(19) United States
(12) Patent Application Publication
(10) Pub. No.: US 2017/0031881 A1
(43) Pub. Date: Feb. 2, 2017

(54) METHOD FOR CREATING WEB PROGRAM AND CORRESPONDING TABLE INTERFACE ACCORDING TO COLUMN COMMENT

(71) Applicant: CHENG SHIU UNIVERSITY, KAOHSIUNG CITY (TW)

(72) Inventor: SHIH-HSIN CHEN, KAOHSIUNG CITY (TW)

(21) Appl. No.: 14/814,678

(22) Filed: Jul. 31, 2015

(51) Int. Cl. G06F 17/22; G06F 17/30; G06F 17/24

(52) U.S. Cl. CPC G06F 17/2247; G06F 17/24; G06F 17/30595; G06F 17/30339; G06F 17/30896

(57) ABSTRACT

A method for creating web programs and corresponding table interfaces according to column comments is revealed. The method features on that codes predefined are stored in the comment of each column in a table respectively and each code corresponds to a function. Then attribute data and the code of each column are obtained by metadata of a relational database. A program required for retrieving and storing data in the relational database is produced according to the attribute data and to the code. Thus a corresponding web code file is created. Finally, a table interface and a program for processing web pages of each column corresponding to the function are created by a web editing system according to the web code file. Thereby web application development is dramatically accelerated.

### BACKGROUND OF THE INVENTION

Fields of the Invention

The present invention relates to a method for creating web programs and corresponding table interfaces according to column comments, especially to a method in which codes predefined are stored in a comment of each column in a table respectively and each code corresponds to a function. Then attribute data and the code of each column are obtained by metadata of a relational database. Next a corresponding web code file is created according to the attribute data and the code so as to generate a table interface e and a program for processing web pages of each column corresponding to the function. Thereby the web application development is significantly accelerated.

Descriptions of Related Art

Due to low-level electronic commerce of small business, the establishment of the web site is outsourced for higher efficiency and professional standards. However, under the complicated internet environment getting more competitive and having fast changes in goods and services, efficiency and flexibility are key factors in having successful sales. Thus information technology providers should develop and construct an electronic trading platform as soon as possible for electronic business integration and its application. Once each website update is outsourced, not only the cost is increased, the related discussion and communication are also time-consuming.

Web page editing tools available now include Microsoft Front Page Microsoft Visual Studio, Adobe Dreamweaver, etc. For most of us, website editing is usually left to programmers and web developers as it often requires knowledge of computer operation and programming. To edit a web page, each web page is generated by web designers according to data in files available now. Thus conventional website editing is quite time-consuming. Take web form program as an example. At least one table is required for storage of columns of a form. That means each column in the table is a source of data stored. For example, the data stored can be uploaded file names (photos, videos, documents, etc.), network site data (network address, e-mail account, etc.), accuracy settings of numbers displayed or whether the column is displayed. These all require corresponding front-end interface and back-end program for data processing. When users want to add a picture management function to the table, a new table is added to record content of the picture. While another video management function is added, another table is added to record video content. Even people familiar with web programming language and database take a lot time in editing web page code. Thus the web development is unable to be completed within the period the customers or companies required.

Refer to Taiwanese Pat. Pub. No. 507142, modularized real-time conversion of web editing and display system and method of the same by which users can edit and display web pages on internet are disclosed. Web editors or art editors of the companies can download modularized files from a server to create and edit schematic web pages. After completing the web pages, the web pages are uploaded and stored in the server. However, the data input is limited due to the server programs that build website structure. Moreover, users are unable to add the column content undefined by the database such as name of uploaded files (photos, videos, documents, etc.), network site data (network address, e-mail account, etc.), accuracy settings of numbers displayed or whether the column is displayed mentioned above.

### SUMMARY OF THE INVENTION

Therefore it is a primary object of the present invention to provide a method for creating web programs and corresponding table interfaces according to column comments so as to speed up web application development. First at least one code predefined is stored in the comment of each column in a table and each code corresponds to a function. Then attribute data and the code of each column are obtained by metadata of a relational database. A program for retrieving and storing data in the relational database is generated according to the attribute data and the code and a corresponding web code file is created. Thus a table interface and a program for processing web pages of each column corresponding to the function are created. Thereby the web application development is significantly accelerated.

In order to achieve the above object, a method for creating web programs and corresponding table interfaces according to column comments of the present invention is applied to a web editing system having a relational database. A web developer sets up a comparison table of comments with functions and stores the comparison table in the relational database. The comparison table includes at least one code and a function corresponding to the code. The code is stored in a comment of the corresponding column in the table. Then attribute data and the code of each column are obtained by metadata of the relational database. A program required for retrieving and storing data in the relational database is produced according to the attribute data and the code so as to create a corresponding web code file. Finally, a table interface and a program for processing web pages of each column corresponding to the function are created by a web editing system according to the web code file. Thereby the problem conventional web developers encounter that they need to write corresponding front-end interface and back-end program for data processing while dealing with data undefined in the relational database 1 and storing the data undefined in each column 121 can be solved. Therefore the development of web applications is dramatically speeded up.

The code in the comment of the column in the table can be stored as a numeric value or as a hierarchical language (such as XML, JSON, etc.).

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart showing steps of an embodiment of a method according to the present invention;

FIG. 2 is a block diagram showing structure of a web editing system according to the present invention;

FIG. 3A and FIG. 3B are schematic drawings showing a user's interface displayed when the web editing system is creating a table.

FIG. 4 is a schematic drawing showing a web page of a table interface in a frontend website according to the present invention;

FIG. 5 is a schematic drawing showing a web page of a table interface after clicking on upload photo, upload file or upload video at a frontend website according to the present invention.

### DETAILED DESCRIPTION OF THE PREFERRED EMBODIMENT

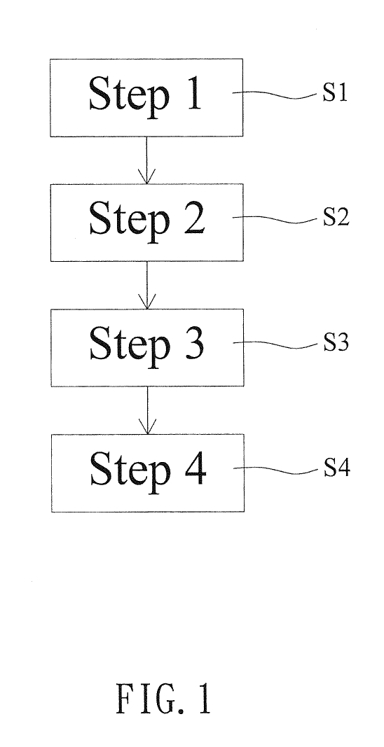

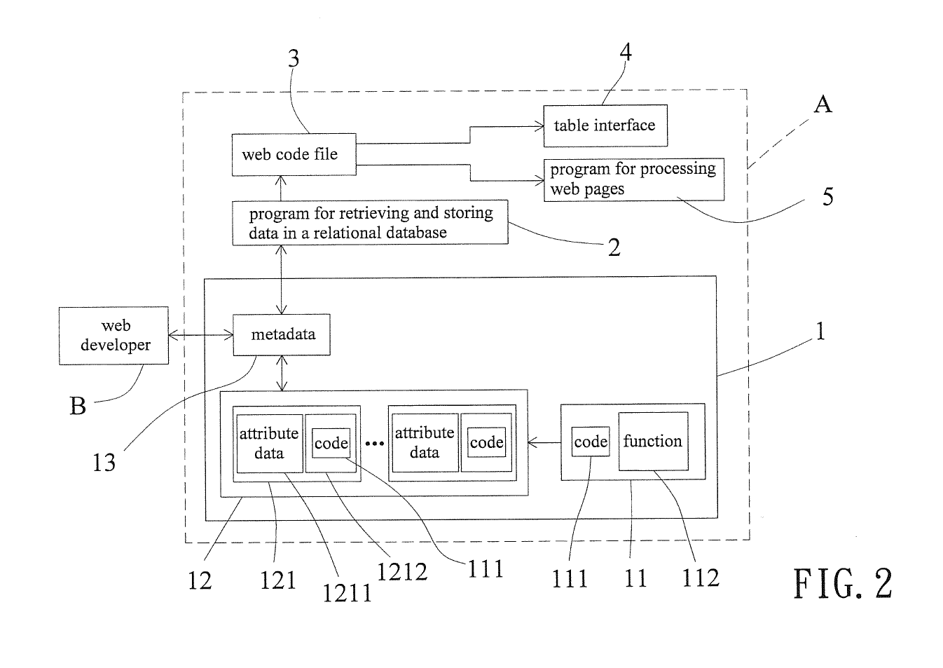

Refer to FIG. 1 and FIG. 2, a method of the present invention is applied to a web editing system A with a relational database 1. The web editing system A can be a conventional web editing system A including a web editor module. Web developers B can select and edit various data in the web editing system A. According to different settings, the data is represented on the web in the form of tables, charts or other types by the web editing system A. As to the relational database 1, it can be, but not limited to, SQL Server, MySQL, DB2 or Oracle. The method of the present invention includes following steps.

Step 1: set up a comparison table 11 of comments with functions by a web developer B and store the comparison table 11 in a relational database 1. As shown in the following table, the comparison table 11 includes at least one code 111 and a function 112 corresponding to the code 111. In this embodiment, take the code “2” as an example. The method of the present invention can be used in combination with different tables to create a table interface 4 with different functions 112. The function 112 whose code 111 is “2” is Upload Photo. Its function not only allows users to upload various image file formats such as JPG, PNG, GIF, etc., upload image button, file select dialog and upload program are also generated automatically in a column 121 of the table. It should be noted that the function 112 whose code 111 is “13” is used to delete image, documents and videos uploaded respectively by the code 111 “2”, “3”, and “4”. Thus files no more required in the relational database 1 are removed.

| code | function | function description | |
|---|---|---|---|
| 0 | Default | 0 represents no content set | |
| 1 | Infeasible | No column is found in the input table and default | |
| | | data is written during back-end processing | |
| 2 | Upload | 1. | Users are allowed to upload image file |
| | Photo | | formats such as JPG, PNG, GIF, etc. |
| | | 2. | The upload image button, file select dialog |
| | | | and upload program are generated |
| | | | automatically in the column of the table. |
| | | | Moreover, instead of the image file name, |
| | | | the image is displayed under the upload |
| | | | image button and in web program for |
| | | | showing data/data display because the |
| | | | column is an image. |
| 3 | Upload | 1. | Supported upload formats include |
| | file | | DOC/DOCX, XLS/XLSX, PPT/PPTX, |
| | | | PDF, TXT, etc. |
| | | 2. | The upload document button, file select |
| | | | dialog and upload program are generated |
| | | | automatically. After the upload being |
| | | | completed, a download link of the uploaded |
| | | | document is immediately shown under the |
| | | | upload document button. The web program |
| | | | for showing data also provides a download |
| | | | link of the uploaded document. |

| | | |
|---|---|---|
| 4 | Upload | Upload videos in MP4 format. The function |
| | Video | and content are the same as the upload photo |
| | | and upload file, including upload video button, |
| | | file select dialog and video upload program. |
| | | After the video being uploaded, a |
| | | corresponding program for displaying the |
| | | video is embedded into the web program to |
| | | display web pages. |
| 5 | Web | The text content input is converted into a |
| | Address | hyperlink display mode so that users can click |
| | | the hyperlink to go directly to the specified |
| | | website. |
| 6 | Email | The text content input is converted into an |
| | Address | e-mail hyperlink display mode. Users can click |
| | | on the e-mail hyperlink to turn on e-mail |
| | | editing software preset in the computer and the |
| | | specified e-mail address has been already |
| | | inserted. |
| 7 | Youtube | Fill in the Youtube video code and the system |
| | Video | of the present invention automatically |
| | address | generates the video embed code and embeds |
| | | the code in the web program. Thus users are |
| | | allowed to display the video automatically. |
| 8 | Telephone | Click a phone number link on the mobile phone |
| | address | and launch the dial program directly. |
| 9 | Decimal | The accuracy of the numeric value being |
| | Format | displayed is to the first digit after the decimal |
| | short | point. |
| 10 | Decimal | The accuracy of the numeric value being |
| | Format | displayed is to the sixth digit after the decimal |
| | long | point. |
| 11 | Year/ | The content of Timestamp: only year, month, |
| | Month/Date | and date are displayed while time is not shown |
| | Format | on this interface. |
| 12 | QR Code | Show QR code according to recorded data |
| 13 | Data | Only the user set up the data can modify and |
| | ownership | delete the data |

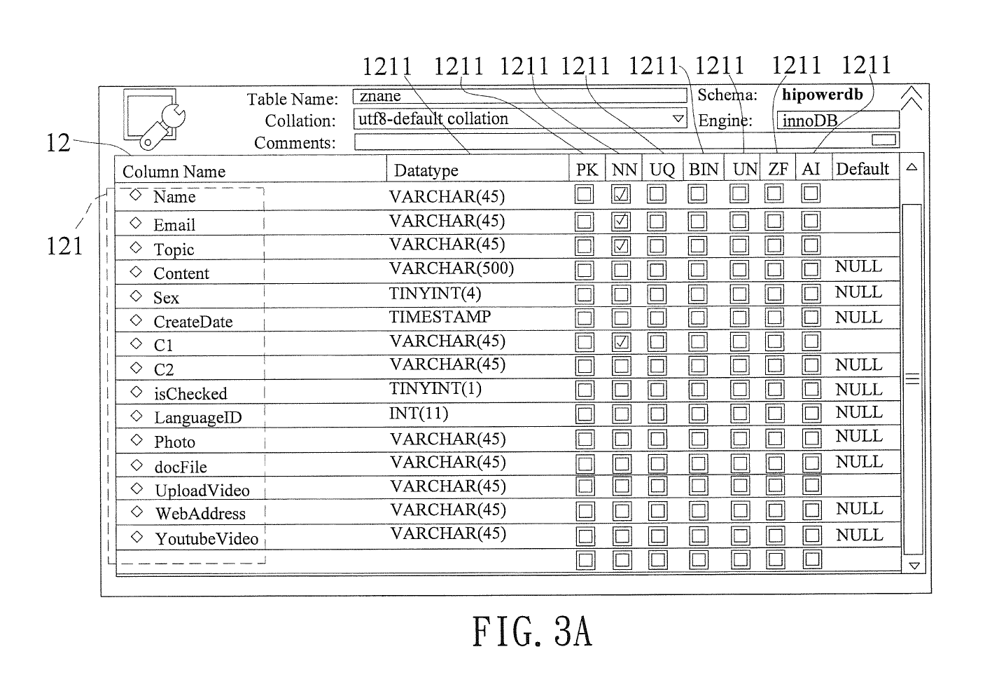

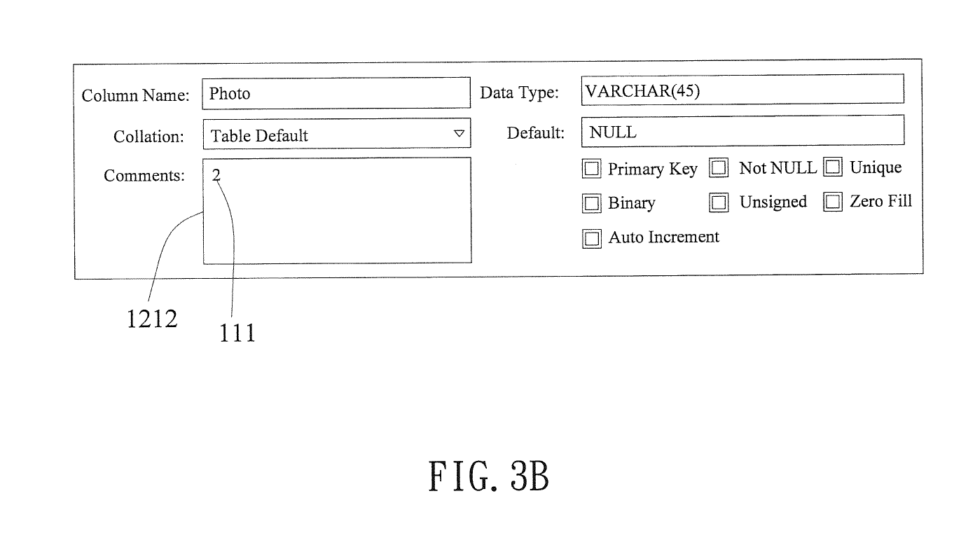

Step 2: store the code 111 “2” into a comment 1212 of the corresponding column 121 in a table 12. Refer to FIG. 3A and FIG. 3B, a user's interface displayed when the web editing system A is creating a table is disclosed. The code 111 can be stored as a numeric value in the comment 1212 of the photo column 121 in the table 12, as the code 111 with number “2” shown in FIG. 3A and FIG. 3B, or as a hierarchical language. For example, when the code 111 “2” is stored as XML (Extensible Markup Language), the comment 1212 is filled with:

<root>
<TypeID>2</TypeID>
</root>

If the code 111 “2” is stored as JSON (JavaScript Object Notation), the comment 1212 is filled with:

### {{“TypeID”:2}}

Step 3: obtain attribute data 1211 and the code 111 of each column 121 by metadata 13 of the relational database 1 and generate a program that retrieves and stores data in the relational database 2 according to the attribute data 1211 and the code 111 of each column 121 so as to create a corresponding web code file 3. The attribute data 1211 consists of a column name parameter, a datatype parameter, a field length parameter (numeric value after datatype), primary key (PK) parameter, a not null (NN) parameter, an unique (UQ) parameter, a binary (BIN) parameter, an unsigned (UN) parameter, a zero fill (ZF) parameter, and an auto increment (AI) parameter, etc. related to the column type. The program for retrieving and storing data in a relational database 2 includes a compiler program and an interpreter program. The compiler program can be, but not limited to, C# language, JAVA language, etc. The interpreter program can be, but not limited to, PHP, JSP, ASP, etc. Moreover, the Meta Data 13 is “Data about Data”. The term is used to explain and describe content, format, structure, uses, etc. of digital data. Thus computer system retrieves and processes digital data according to metadata. The Web developers B can discover the attribute data 1211 of the relational database 1 (such as Column Name parameter, Datatype parameter, etc.) and the code 111 of the comment 1212.

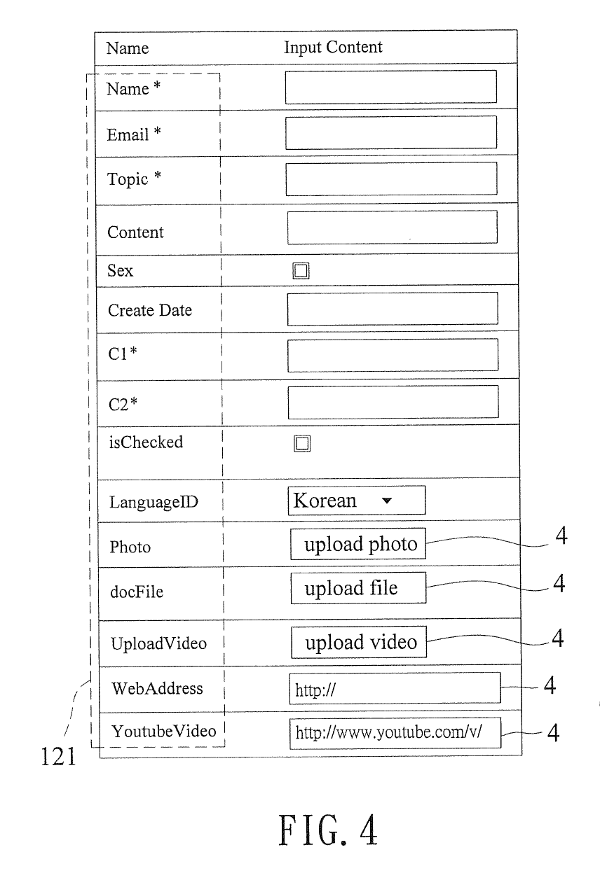

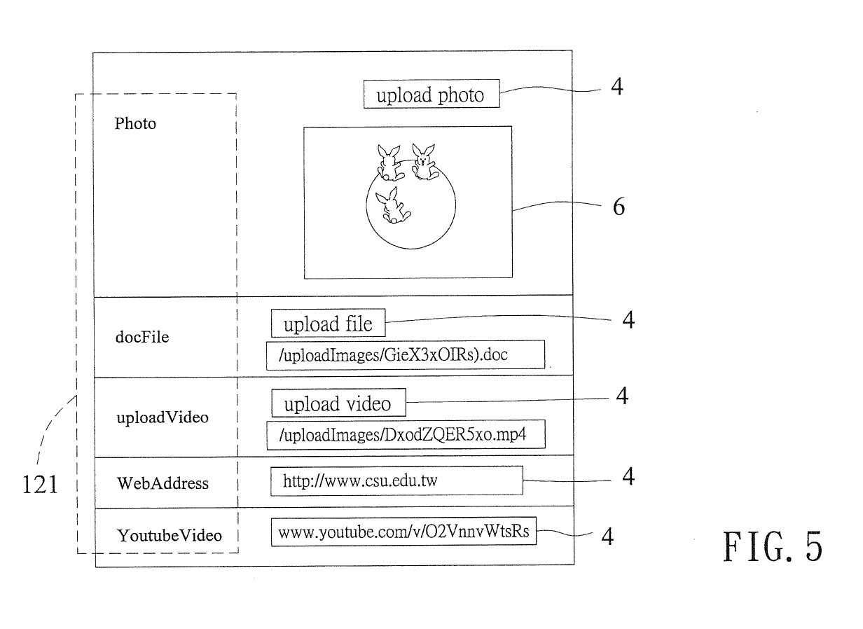

Step 4: create a table interface 4 and a program for processing web pages 5 of each column 121 corresponding to the function 112 according to the web code file 3 by the web editing system A. Refer to FIG. 4, besides the code “2” stored in the comment 1212 of the photo column 121, the code “3”, code “4”, code “5”, and code “7” are stored in the comment 1212 of the column 121 of docFile, UploadVideo, WebAddress and YoutubeVideo respectively. Thus the upload image button, the file select dialog and the upload program are generated automatically in the frontend website according to the docFile column 121. After completing the upload, a download link of the uploaded document is immediately shown under the upload document button. The web program for showing data also provides a download link of the uploaded document. Supported upload formats include DOC/DOCX, XLS/XLSX, PPT/PPTX, PDF, TXT, etc. Videos in MP4 format can be uploaded in the frontend website due to the UploadVideo column 121. The function and content are the same as the upload photo and upload file, including upload button, video select dialog and upload program. After the video being uploaded, a corresponding program for displaying the video is embedded into the web program to display web pages. The text content input is converted into a display mode of hyperlink in the frontend website according to the WebAddress column 121. Thus users can click the hyperlink to go directly to the specified website. According to the YoutubeVideo column 121, the Youtube video code is filled in the frontend website and the system of the present invention automatically generates the video embed code and embeds the code in the web program. Thus users are allowed to display the video automatically.

Thereby the present invention provides a fast and a simple method for creating web program and corresponding table interface according to the column comment. By the code 111 stored in the comment 1212 of each column 121, a table interface 4 and a program for processing web pages 5 of the column 121 corresponding to the function 112 are created. Thus the problem conventional web developers encounter that they need to write corresponding front-end interface and back-end program for data processing while dealing with data undefined in the relational database 1 and storing the data undefined in each column 121 can be solved. Therefore the development of web applications is dramatically speeded up.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for creating web programs and corresponding table interfaces according to column comments and being applied to a web editing system having a relational database comprising the steps of:
Step 1: setting up a comparison table of comments with functions by a web developer and storing the comparison table in a relational database; the comparison table of comments with functions including at least one code and a function corresponding to the code;
Step 2: storing the code into a comment of the corresponding column in a table;
Step 3: obtaining attribute data and the code of each of the column by metadata of the relational database and generating a program that retrieves and stores data in the relational database according to the attribute data and the code obtained so as to create a corresponding web code file; and
Step 4: creating a table interface and a program for processing web pages of each of the column corresponding to the function according to the web code file by the web editing system.

2. The method as claimed in claim 1, wherein the code is stored in the comment of the column in the table as a numeric value.

3. The method as claimed in claim 1, wherein the code is stored in the comment of the column in the table as a hierarchical language.

4. The method as claimed in claim 3, wherein the hierarchical language is Extensible Markup Language (XML) or JavaScript Object Notation (JSON).

5. The method as claimed in claim 1, wherein the attribute data includes a column name parameter, a datatype parameter, a field length parameter, a primary key (PK) parameter, a not null (NN) parameter, an unique (UQ) parameter, a binary (BIN) parameter, an unsigned (UN) parameter, a zero rill (ZF) parameter, and an auto increment (AI) parameter.

6. The method as claimed in claim 1, wherein the relational database is SQL Server, MySQL, DB2 or Oracle.

7. The method as claimed in claim 1, wherein the program for retrieving and storing data in a relational database includes a compiler program and an interpreter program.
